(19) United States
(12) Patent Application Publication
(10) Pub. No.: US 2025/0390870 A1
(43) Pub. Date: Dec. 25, 2025

(54) PAYMENT SYSTEM FOR DISPLAYING SUBSCRIBER'S SETTING IMAGE

(71) Applicant: NHNKCP Corp., Seoul (KR)

(72) Inventor: Jun Seok PARK, Seoul (KR)

(73) Assignee: NHNKCP Corp., Seoul (KR)

(21) Appl. No.: 18/830,638

(22) Filed: Sep. 11, 2024

(30) Foreign Application Priority Data
Jun. 24, 2024 (KR) 10-2024-0081848

(51) Int. Cl. G06Q 20/40; G06Q 20/02

(52) U.S. Cl. CPC G06Q 20/4014; G06Q 20/027

(57) ABSTRACT

The present invention relates to a payment system for displaying a subscriber's setting image, which can induce immersion and interest during payment by displaying a personalized image set by a customer in real time through a built-in display or an external display of a payment terminal while payment is being performed.

### CROSS-REFERENCE TO RELATED APPLICATION(S)

This application claims priority from Korean Patent Application No. 10-2024-0081848, filed on Jun. 24, 2024, in the Korean Intellectual Property Office, the disclosure of which is incorporated herein by reference in its entirety.

### BACKGROUND

### 1. Field

The following description relates to payment technology, and more particularly, to a payment system for displaying a subscriber's setting image.

### 2. Description of Related Art

In the case of the existing credit card payment or mobile pay payment, only a payment-related screen is simply displayed on a display of a payment terminal while the payment is being performed, or an advertiser's advertisement is implemented in a pop-up form on the payment-related screen.

The inventors of the present invention have studied an improved payment technology that may induce immersion and interest during payment by displaying a personalized image set by a customer in real time through a built-in display or an external display of the payment terminal while the payment is being performed.

### RELATED ART DOCUMENT

### Patent Document

(Patent Document 1) Korean Patent Laid-Open Publication No. 10-2020-0121012 (Published on Oct. 23, 2020)

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The following description relates to a payment system for displaying a subscriber's setting image, which can induce immersion and interest during payment by displaying a personalized image set by a customer in real time through a built-in display or an external display of a payment terminal while payment is being performed.

In one general aspect, a payment system for displaying a subscriber's setting image includes: a payment terminal including: a key input module that receives a user operation; a nonvolatile memory that stores a payment app program code; a communication module that communicates with a value added network (VAN) company server or a payment gateway (PG) company server; a built-in display that outputs a payment app execution screen; and a processor that processes payment by executing a payment app stored in the non-volatile memory according to the user operation through the key input module, performs control to generate a payment approval request and transmit the generated payment approval request to the VAN company server or the PG company server through the communication module, and controls a payment approval result received from the VAN company server or the PG company server through the communication module to be displayed through the built-in display, in which the payment app includes: a subscriber information processing unit that transmits a card number replacement token to the VAN company server or the PG company server to request subscriber information corresponding to the card number replacement token, and receives subscriber information, which includes a subscriber's card number corresponding to the card number replacement token and the subscriber's setting image or the subscriber's setting image index, from the VAN company server or the PG company server; a payment processing unit that generates a payment approval request message including the subscriber's card number and the payment information included in the subscriber information received by the subscriber information processing unit, transmits the generated payment approval request message to the VAN company server or the PG company server, and receives a payment approval result message from the VAN company server or the PG company server to process the card payment; and an image processing unit that processes the subscriber's setting image or the subscriber's setting image stored in the subscriber's setting image index, which is included in the subscriber information received by the subscriber information processing unit, to be displayed on a screen for a time when the payment is being processed by the payment processing unit.

The image processing unit may process the subscriber's setting image to be displayed on the screen through the built-in display.

The image processing unit may process the subscriber's setting image to be displayed on a screen through an external display provided separately from the built-in display.

The external display may be a hologram display or a hologram projector that displays the subscriber's setting image as a hologram.

The subscriber information may further include event information.

The payment processing unit may reflect an event included in the event information to process the card payment.

The card number replacement token may be the subscriber's ID, the subscriber's mobile terminal phone number, the subscriber's e-mail address, or a one time code (OTC) issued for requesting subscriber information.

The payment terminal may be a user's mobile terminal, a merchant point-of-sale (POS) terminal, or an offline kiosk terminal.

The system may further include the VAN company server or the PG company server that receives the subscriber information request corresponding to the card number replacement token from the payment terminal, checks the subscriber information corresponding to the card number replacement token with a subscriber management server, and transmits the subscriber information, which includes the subscriber's card number corresponding to the checked card number replacement token and the subscriber's setting image or the subscriber's setting image index, to the payment terminal.

The VAN company server or the PG company server may receive the payment approval request message, which includes the subscriber's card number and the payment information included in the subscriber information, from the payment terminal, relay the received payment approval request message to a card company server, receive the payment approval result message from the card company server, and relay the received payment approval result message to the payment terminal.

The system may further include a subscriber management server that registers and stores the subscriber's card number and the subscriber's setting image or the subscriber's setting image index.

The subscriber management server may include: a member management unit that performs member management including member registration for a subscriber, and matches the subscriber's card number with subscriber's member information to store the subscriber's card number in a database (DB); an image management unit that receives the subscriber's setting image from a subscriber registered as a member by the member management unit and matches the received subscriber's setting image with the subscriber's member information to store the received subscriber's setting image in the DB; and a subscriber information inquiry unit that searches the DB in response to a subscriber information inquiry request corresponding to the card number replacement token from the VAN company server or the PG company server to acquire the subscriber information that includes the subscriber's card number corresponding to the card number replacement token and the subscriber's setting image or the subscriber's setting image index and provide the acquired subscriber information to the VAN company server or the PG company server.

The subscriber's member information may include the subscriber's name, the subscriber's ID, the subscriber's mobile terminal phone number, and the subscriber's e-mail address.

The subscriber management server may further include a service charge payment processing unit that processes service charge payment for providing the subscriber setting image display service.

The service charge payment processing unit may provide a service charge payment user interface (UI) to a user mobile terminal carried by a subscriber, and process the service charge payment for providing the subscriber setting image display service through the service charge payment UI.

Other features and aspects will be apparent from the following detailed description, the drawings, and the claims.

### BRIEF DESCRIPTION OF THE DRAWINGS

FIG. 1 is a block diagram illustrating a configuration of a payment system for displaying a subscriber's setting image according to an embodiment of the present invention.

FIG. 2 is a block diagram illustrating a configuration of a payment terminal of the payment system for displaying a subscriber's setting image according to an embodiment of the present invention.

FIG. 3 is a block diagram illustrating a configuration of a payment app executed in the payment terminal of the payment system for displaying a subscriber's setting image according to an embodiment of the present invention.

FIG. 4 is a block diagram illustrating a configuration of a subscriber management server of the payment system for displaying a subscriber's setting image according to an embodiment of the present invention.

FIG. 5 is a flowchart illustrating a display operation of the payment terminal of the payment system for displaying a subscriber's setting image according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, the present invention will be described in detail so that those skilled in the art can easily understand and reproduce the present invention through preferred embodiments described with reference to the accompanying drawings. Although specific embodiments are illustrated in the drawings and described in detail, they are not intended to limit the various embodiments of the present invention to any particular form.

When it is determined that the detailed description of the known functions or configurations in describing the present invention may obscure the gist of the embodiments of the present invention, the detailed description thereof will be omitted.

It is to be understood that when one component is referred to as being “connected to” or “coupled to” another component, the one component may be connected directly to or coupled directly to the other component or may be connected to or coupled to the other component with the other component interposed therebetween.

On the other hand, it is to be understood that when one element is referred to as being “connected directly to” or “coupled directly to” another element, it may be connected to or coupled to the other element with no other element intervening therebetween.

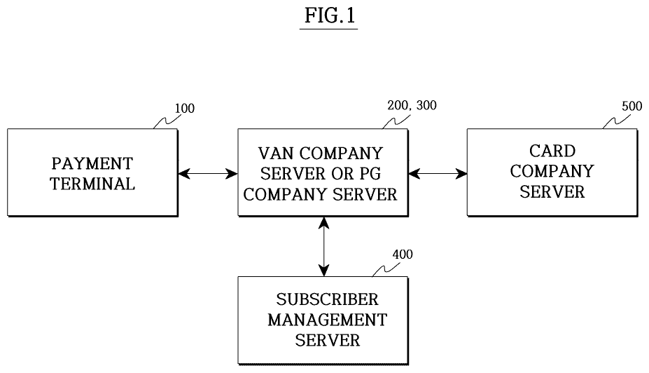

FIG. 1 is a block diagram illustrating a configuration of a payment system for displaying a subscriber's setting image according to an embodiment of the present invention. As illustrated in FIG. 1, the payment system for displaying a subscriber's setting image according to the present embodiment includes a payment terminal 100, a value added network (VAN) company server 200 or a payment gateway (PG) company server 300, a subscriber management server 400, and a card company server 500.

The payment terminal 100 requests subscriber information corresponding to a card number replacement token from the VAN company server 200 or the PG company server 300, receives the subscriber information corresponding to the card number replacement token from the VAN company server 200 or the PG company server 300, generates a payment approval request based on the subscriber information, transmits the generated payment approval request to the VAN company server 200 or the PG company server 300, and receives a payment approval result from the VAN company server 200 or the PG company server 300.

In this case, the card number replacement token may be a subscriber's identification (ID), the subscriber's mobile terminal phone number, the subscriber's e-mail address, or a one-time code (OTC) issued for requesting the subscriber information, and the payment terminal 100 may be a user mobile terminal carried by the subscriber, a merchant point-of-sale (POS) terminal installed in an offline merchant, or an offline kiosk terminal installed in a public event venue such as a concert hall, a sports stadium, or an exhibition hall.

The VAN company server 200 or the PG company server 300 receives the subscriber information request corresponding to the card number replacement token from the payment terminal 100, checks the subscriber information corresponding to the card number replacement token with the subscriber management server 400, and transmits the subscriber information corresponding to the checked card number replacement token to the payment terminal 100. In addition, the VAN company server 200 or the PG company server 300 relays the payment approval request generated based on the subscriber information transmitted from the payment terminal 100 to the card company server 500, receives the payment approval result from the card company server 500, and relays the received payment approval result to the payment terminal 100.

In this case, in order to display a personalized image set by a customer in real time through a built-in display or an external display of the payment terminal while the payment is being performed, the VAN company server 200 or the PG company server 300 may be implemented to acquire subscriber information, which includes the subscriber's card number corresponding to the card number replacement token and the subscriber's setting image or the subscriber's setting image index, from the subscriber management server 400, and transmit the acquired subscriber information to the payment terminal.

Meanwhile, the VAN company server 200 or the PG company server 300 may be implemented to receive a payment approval request message, which includes the subscriber's card number and the payment information included in the subscriber information, from the payment terminal 100, relay the received payment approval request message to the card company server 500, receive a payment approval result message from the card company server 500, and relay the received payment approval result message to the payment terminal 100.

The subscriber management server 400 performs member management including member registration for a subscriber, matches the subscriber's card number with the subscriber's member information to store the subscriber's card number in a database (DB), searches the DB in response to a subscriber information inquiry request corresponding to the card number replacement token from the VAN company server 200 or the PG company server 300 to acquire the subscriber information corresponding to the card number replacement token, and provides the acquired subscriber information to the VAN company server 200 or the PG company server 300.

In this case, to display a personalized image set by a customer in real time through the built-in display or the external display of the payment terminal while the payment is being performed, the subscriber management server 400 may be implemented to register and store the subscriber's card number and the subscriber's setting image or the subscriber's setting image index. Meanwhile, the subscriber's setting image may be a still image, a moving image, or a multi-video image in which voice and image are combined.

When the subscriber information inquiry request corresponding to the card number replacement token is received from the VAN company server 200 or the PG company server 300, the subscriber management server 400 includes the subscriber's card number corresponding to the card number replacement token and the subscriber's setting image or the subscriber's setting image index in the subscriber information, and provides the subscriber information to the VAN company server 200 or the PG company server 300.

The card company server 500 receives the payment approval request generated from a payment terminal 100 relayed through the VAN company server 200 or the PG company server 300 to process the payment approval, and transmits the payment approval result to the VAN company server 200 or the PG company server 300. Then, the VAN company server 200 or the PG company server 300 relays the payment approval result generated from the card company server 500 to the payment terminal 100.

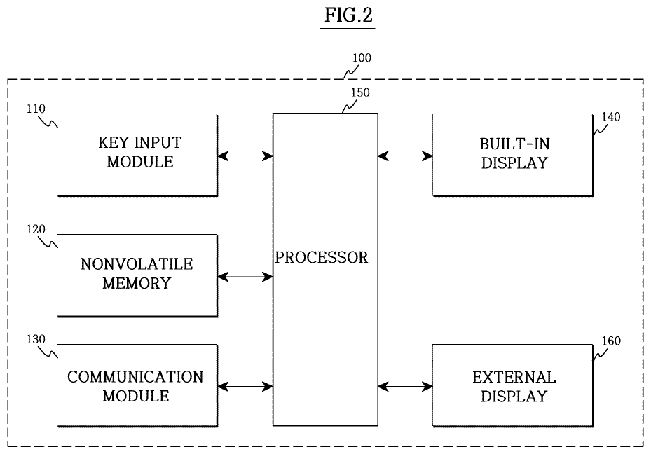

FIG. 2 is a block diagram illustrating a configuration of the payment terminal of the payment system for displaying a subscriber's setting image according to an embodiment of the present invention. As illustrated in FIG. 2, the payment terminal 100 of the payment system for displaying a subscriber's setting image according to the present invention includes a key input module 110, a nonvolatile memory 120, a communication module 130, a built-in display 140, and a processor 150.

The key input module 110 receives a user operation. In this case, the key input module 110 may be implemented in a form in which hardware type mechanical buttons are arranged or in a form in which software type touch buttons are arranged.

The nonvolatile memory 120 stores a payment app program code. In addition, the nonvolatile memory 120 stores an operating system (OS) program code. For example, the nonvolatile memory 120 may be implemented in the form of an electrically erasable and programmable read only memory (EEPROM), a flash memory, a hard disk drive (HDD), a solid state drive (SSD), etc.

The communication module 130 communicates with the VAN company server 200 or the PG company server 300. For example, the communication module 130 may be implemented in the form of a wireless modem supporting Long Term Evolution (LTE) or 4th Generation (4G) or 5G-based mobile communication or a wired modem supporting transmission control protocol/Internet protocol (TCP/IP)-based Ethernet communication.

The built-in display 140 outputs various screens including the payment terminal operation, and outputs a payment app execution screen. For example, the built-in display 140 may be implemented in the form of a light emitting diode (LED) display, an organic light emitting diode (OLED) display, a quantum dot light emitting diode (QLED) display, etc., but is not limited thereto.

The processor 150 controls the entire device, and executes a payment app stored in the nonvolatile memory 120 according to the user operation through the key input module 110 to perform the payment processing, performs control to generate the payment approval request and transmit the generated payment approval request to the VAN company server 200 or the PG company server 300 through the communication module 130, and controls the payment approval result received from the VAN company server 200 or the PG company server 300 through the communication module 130 to be displayed through the built-in display 140.

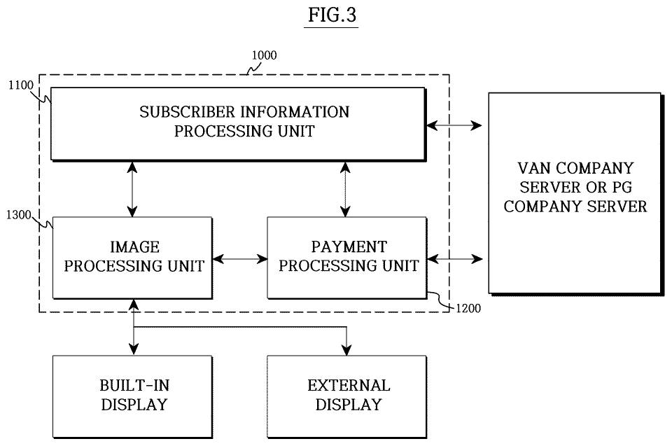

FIG. 3 is a block diagram illustrating a configuration of the payment app executed in the payment terminal of the payment system for displaying a subscriber's setting image according to an embodiment of the present invention. As illustrated in FIG. 3, a payment app 1000 includes a subscriber information processing unit 1100, a payment processing unit 1200, and an image processing unit 1300.

The subscriber information processing unit 1100 transmits the card number replacement token to the VAN company server 200 or the PG company server 300 to request the subscriber information corresponding to the card number replacement token, and receives the subscriber information, which includes the subscriber's card number corresponding to the card number replacement token and the subscriber's setting image or the subscriber's setting image index, from the VAN company server 200 or the PG company server 300.

In this case, the card number replacement token may be the subscriber's ID, the subscriber's mobile terminal phone number, the subscriber's e-mail address, or the OTC issued for requesting the subscriber information, the subscriber's card number may be a real card number or an OTC card number, and the subscriber's setting image index may be a uniform resource locator (URL) address where the subscriber's setting image is stored.

Meanwhile, when the card number replacement token is the OTC issued for requesting the subscriber information, the OTC issuance procedure may be performed prior to requesting the subscriber information, and since the OCT issuance procedure is a common matter published prior to this application, a detailed description thereof will be omitted.

The VAN company server 200 or the PG company server 300 that receives the subscriber information request corresponding to the card number replacement token transmitted by the subscriber information processing unit 1100 checks the subscriber information corresponding to the card number replacement token with the subscriber management server 400, acquires the subscriber information including the subscriber's card number corresponding to the card number replacement token and the subscriber's setting image or the subscriber's setting image index, and transmits the acquired subscriber information to the payment terminal 100, and the subscriber information processing unit 1100 receives the acquired subscriber information.

The payment processing unit 1200 generates the payment approval request message including the subscriber's card number and the payment information included in the subscriber information received by the subscriber information processing unit 1100, transmits the generated payment approval request message to the VAN company server 200 or the PG company server 300, and receives the payment approval result message from the VAN company server 200 or the PG company server 300 to process the card payment. In this case, the payment information may include a payment amount, a payment product or service identification information, payment terminal identification information, a payment date and time, etc.

The VAN company server 200 or the PG company server 300 that receives the payment approval request message including the card number and the payment information transmitted by the payment processing unit 1200 relays the payment approval request to the card company server 500 and relays the payment approval result text received from the card company server 500 to the payment terminal 100, and the payment processing unit 1200 receives the payment approval result text and completes the payment processing.

The image processing unit 1300 processes the subscriber's setting image or the subscriber's setting image stored in the subscriber's setting image index, which is included in the subscriber information received by the subscriber information processing unit 1100, to be displayed on a screen for a time when the payment is being processed by the payment processing unit 1200. In this case, the subscriber's setting image may be the still image, the moving image, or the multi-video image in which audio and video are combined.

Meanwhile, the image processing unit 1300 may be implemented to process the subscriber's setting image to be displayed on the screen through the built-in display 140, or may be implemented to process the subscriber's setting image to be displayed on the screen through the external display 160 provided separately from the built-in display 140. For example, the external display 160 may be a hologram display or a hologram projector that displays the subscriber's setting image as a hologram.

Meanwhile, when the subscriber's setting image index is included in the subscriber information, the image processing unit 1300 may be implemented to directly access a storage location indicated by the subscriber's setting image index to acquire the subscriber's setting image when displaying the subscriber's setting image on the screen through the built-in display 140.

However, when displaying the subscriber's setting image on the screen through the external display 160, the image processing unit 1300 may be implemented to directly access the storage location indicated by the subscriber's setting image index to acquire the subscriber's setting image, or may be implemented to transmit the subscriber's setting image index to the external display 160 so that the external display 160 may access the storage location indicated by the subscriber's setting image index to acquire the subscriber's setting image.

By the above-described implementation, according to the present invention, by inducing the immersion and interest during the payment by displaying the personalized image set by the customer in real time through the built-in display or external display of the payment terminal while the payment is being made, it is possible to increase bonding with customers and improve customer loyalty.

Meanwhile, according to an additional aspect of the present invention, the subscriber information may further include event information. For example, the event may be a discount event, an accumulated point use event, etc., but is not limited thereto. In this case, the payment processing unit 1200 may be implemented to process the card payment by reflecting the event included in the event information. For example, when the event is the discount event, the payment processing unit 1200 may be implemented to process the card payment for the amount by reflecting the discount amount included in the discount event information and deducting the discount amount from the payment amount.

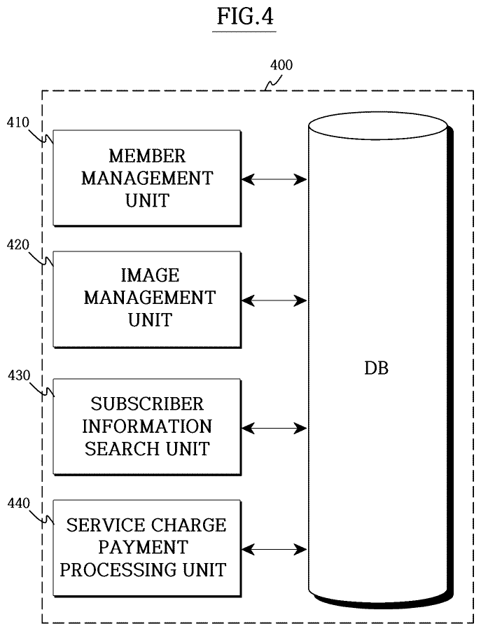

FIG. 4 is a block diagram illustrating a configuration of the subscriber management server of the payment system for displaying a subscriber's setting image according to an embodiment of the present invention. As illustrated in FIG. 4, the subscriber management server 400 may include a member management unit 410, an image management unit 420, and a subscriber information inquiry unit 430.

The member management unit 410 performs member management including member registration for a subscriber, and matches the subscriber's card number with the subscriber's member information to store the subscriber's card number in the DB. In this case, the subscriber's member information may include the subscriber's name, the subscriber's ID, the subscriber's mobile terminal phone number, and the subscriber's e-mail address.

The image management unit 420 receives the subscriber's setting image from the subscriber registered by the member management unit 410, and matches the subscriber's setting image with the subscriber's member information to store the subscriber's setting image in the DB. In this case, the image management unit 420 may be implemented to directly upload at least one setting image of the subscriber from the user mobile terminal carried by the subscriber, and match the subscriber's uploaded setting image with the subscriber's member information to store the subscriber's uploaded setting image in the DB.

On the other hand, the image management unit 420 may be implemented to register the subscriber's setting image by making a plurality of standardized images in advance and storing the plurality of standardized images in the DB, displaying a plurality of standardized image items using the user mobile terminal carried by the subscriber, selecting at least one desired image item from the subscriber, and matching the selected image item with the subscriber's member information to store the selected image item in the DB.

The subscriber information inquiry unit 430 searches the DB in response to the subscriber information inquiry request corresponding to the card number replacement token from the VAN company server 200 or the PG company server 300 to acquire the subscriber information that includes the subscriber's card number corresponding to the card number replacement token, the subscriber's setting image, or the subscriber's setting image index, and provides the acquired subscriber information to the VAN company server 200 or the PG company server 300.

The card number replacement token may be the subscriber's ID, the subscriber's mobile terminal phone number, the subscriber's e-mail address, or the OTC issued for requesting the subscriber information, and when the subscriber information request corresponding to the card number replacement token is received from the payment terminal 100, the VAN company server 200 or the PG company server 300 checks the subscriber's member information corresponding to the card number replacement token in the DB through the subscriber information inquiry unit 430 to acquire the subscriber information that includes the subscriber's card number and the subscriber's setting image or the subscriber's setting image index and transmit the acquired subscriber information from the payment terminal 100.

Then, the payment terminal 100 that receives the subscriber information that includes the subscriber's card number corresponding to the card number replacement token and the subscriber's setting image or the subscriber's setting image index performs the payment using the subscriber's card number included in the subscriber information, and displays the subscriber's setting image or the subscriber's setting image stored in the subscriber's setting image index, which is included in the subscriber information, through the built-in display or the external display while the payment is being performed.

By the above-described implementation, according to the present invention, by inducing the immersion and interest during the payment by displaying the personalized image set by the customer in real time through the built-in display or external display of the payment terminal while the payment is being made, it is possible to increase the bonding with customers and improve the customer loyalty.

Meanwhile, according to an additional aspect of the present invention, the subscriber management server 400 may further include a service charge payment processing unit 440. The service charge payment processing unit 440 processes the service charge payment for providing the subscriber setting image display service.

For example, the service charge payment processing unit 440 may be implemented to provide the service charge payment UI to the user mobile terminal carried by the subscriber, and process the service charge payment for providing the subscriber setting image display service through the service charge payment UI.

In this case, the service charge payment processing unit 440 may be implemented to process the payment for the subscriber setting image display service usage fee in the form of a physical card payment, a mobile card payment, a mobile carrier small amount payment, an account transfer, etc.

Through this implementation, the present invention can create a new revenue model by providing the subscriber setting image display service as a paid service, so it is possible to obtain continuous revenue through paid subscription to the subscriber setting image display service.

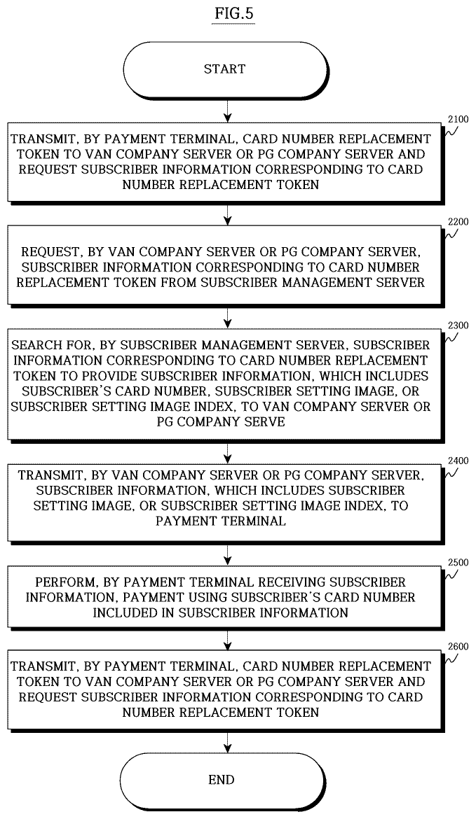

The display operation of the payment terminal of the payment system for displaying a subscriber's setting image according an embodiment of the present invention will be described with reference to FIG. 5. FIG. 5 is a flowchart illustrating the display operation of the payment terminal of the payment system for displaying a subscriber's setting image according to an embodiment of the present invention.

First, in operation 2100, the payment terminal executing the payment app transmits the card number replacement token to the VAN company server or the PG company server to request the subscriber information corresponding to the card number replacement token.

Then, in operation 2200, the VAN company server or the PG company server that receives the subscriber information request corresponding to the card number replacement token requests the subscriber management server to inquire about the subscriber information corresponding to the card number replacement token.

Then, in operation 2300, the subscriber management server searches the DB for the subscriber information corresponding to the card number replacement token from to provide the subscriber information, which includes the subscriber's card number and the subscriber's setting image or the subscriber's setting image index, to the VAN company server or the PG company server.

Then, in operation 2400, the VAN company server or the PG company server transmits the subscriber information, which includes the subscriber's card number provided by the subscriber management server and the subscriber's setting image or the subscriber's setting image index, to the payment terminal.

Then, in operation 2500, the payment terminal that receives the subscriber information that includes the subscriber's card number and the subscriber's setting image or the subscriber's setting image index performs the payment using the subscriber's card number included in the subscriber information.

Then, in operation 2600, the payment terminal displays the subscriber's setting image or the subscriber's setting image stored in the subscriber's setting image index (Index) included in the subscriber information through the built-in display or the external display while the payment is being performed.

By the above-described implementation, according to the present invention, by inducing the immersion and interest during the payment by displaying the personalized image set by the customer in real time through the built-in display or external display of the payment terminal while the payment is being performed, it is possible to increase bonding with customers and improve customer loyalty.

According to the present invention, by inducing the immersion and interest during the payment by displaying the personalized image set by the customer in real time through the built-in display or external display of the payment terminal while the payment is being performed, it is possible to increase bonding with customers and improve customer loyalty.

Various embodiments disclosed in this specification and drawings are merely specific examples presented to aid understanding and are not intended to limit the scope of various embodiments of the present invention.

Therefore, the scope of various embodiments of the present invention should be interpreted as including all changes or modifications derived based on the technical idea of various embodiments of the present invention, in addition to the embodiments described herein.

The present invention can be industrially applied in the payment-related technology field and its application technology fields.

1. A payment system for displaying a subscriber's setting image, comprising:
a payment terminal including:
a key input module that receives a user operation;
a nonvolatile memory that stores a payment app program code;
a communication module that communicates with a value added network (VAN) company server or a payment gateway (PG) company server;
a built-in display that outputs a payment app execution screen; and
a processor that processes payment by executing a payment app stored in the non-volatile memory according to the user operation through the key input module, performs control to generate a payment approval request and transmit the generated payment approval request to the VAN company server or the PG company server through the communication module, and controls a payment approval result received from the VAN company server or the PG company server through the communication module to be displayed through the built-in display,
wherein the payment app includes:
a subscriber information processing unit that transmits a card number replacement token to the VAN company server or the PG company server to request subscriber information corresponding to the card number replacement token, and receives the subscriber information, which includes a subscriber's card number corresponding to the card number replacement token and the subscriber's setting image or the subscriber's setting image index, from the VAN company server or the PG company server;
a payment processing unit that generates a payment approval request message including the subscriber's card number and the payment information included in the subscriber information received by the subscriber information processing unit, transmits the generated payment approval request message to the VAN company server or the PG company server, and receives a payment approval result message from the VAN company server or the PG company server to process the card payment; and
an image processing unit that processes the subscriber's setting image or the subscriber's setting image stored in the subscriber's setting image index, which is included in the subscriber information received by the subscriber information processing unit, to be displayed on a screen for a time when the payment is being processed by the payment processing unit.

2. The system of claim 1, wherein the image processing unit processes the subscriber's setting image to be displayed on the screen through the built-in display.

3. The system of claim 1, wherein the image processing unit processes the subscriber's setting image to be displayed on a screen through an external display provided separately from the built-in display.

4. The system of claim 3, wherein the external display is a hologram display or a hologram projector that displays the subscriber's setting image as a hologram.

5. The system of claim 1, wherein the subscriber information further includes event information.

6. The system of claim 5, wherein the payment processing unit reflects an event included in the event information to process the card payment.

7. The system of claim 1, wherein the card number replacement token is the subscriber's ID, the subscriber's mobile terminal phone number, the subscriber's e-mail address, or a one time code (OTC) issued for requesting subscriber information.

8. The system of claim 1, wherein the payment terminal is a user's mobile terminal, a merchant point-of-sale (POS) terminal, or an offline kiosk terminal.

9. The system of claim 1, further comprising the VAN company server or the PG company server that receives the subscriber information request corresponding to the card number replacement token from the payment terminal, checks the subscriber information corresponding to the card number replacement token with a subscriber management server, and transmits the subscriber information, which includes the subscriber's card number corresponding to the checked card number replacement token and the subscriber's setting image or the subscriber's setting image index, to the payment terminal.

10. The system of claim 9, wherein the VAN company server or the PG company server receives the payment approval request message, which includes the subscriber's card number and the payment information included in the subscriber information, from the payment terminal, relays the received payment approval request message to a card company server, receives the payment approval result message from the card company server, and relays the received payment approval result message to the payment terminal.

11. The system of claim 10, further comprising a subscriber management server that registers and stores the subscriber's card number and the subscriber's setting image or the subscriber's setting image index.

12. The system of claim 11, wherein the subscriber management server includes:
a member management unit that performs member management including member registration for a subscriber, and matches the subscriber's card number with subscriber's member information to store the subscriber's card number in a database (DB);
an image management unit that receives the subscriber's setting image from a subscriber registered as a member by the member management unit and matches the received subscriber's setting image with the subscriber's member information to store the received subscriber's setting image in the DB; and
a subscriber information inquiry unit that searches the DB in response to a subscriber information search request corresponding to the card number replacement token from the VAN company server or the PG company server to acquire the subscriber information that includes the subscriber's card number corresponding to the card number replacement token and the subscriber's setting image or the subscriber's setting image index and provide the acquired subscriber information to the VAN company server or the PG company server.

13. The system of claim 12, wherein the subscriber's member information includes the subscriber's name, the subscriber's ID, the subscriber's mobile terminal phone number, and the subscriber's e-mail address.

14. The system of claim 12, wherein the subscriber management server further includes a service charge payment processing unit that processes service charge payment for providing a subscriber setting image display service.

15. The system of claim 14, wherein the service charge payment processing unit provides a service charge payment user interface (UI) to a user mobile terminal carried by a subscriber, and processes the service charge payment for providing the subscriber setting image display service through the service charge payment UI.
